(19) United States
(12) Patent Application Publication
(10) Pub. No.: US 2024/0075947 A1
(43) Pub. Date: Mar. 7, 2024

(54) FAILURE DIAGNOSIS SYSTEM, FAILURE DIAGNOSIS METHOD, AND NON-TRANSITORY STORAGE MEDIUM

(71) Applicant: NEC Corporation, Minato-ku, Tokyo (JP)

(72) Inventors: Yuma Yazaki, Tokyo (JP); Takahiro Murata, Tokyo (JP); Yusuke Koitabashi, Tokyo (JP); Sachiko Ohishi, Tokyo (JP)

(73) Assignee: NEC Corporation, Minato-ku, Tokyo (JP)

(21) Appl. No.: 18/273,916

(22) PCT Filed: Jan. 28, 2021
(86) PCT No.: PCT/JP2021/002972

§ 371 Date: Jul. 24, 2023

(51) Int. Cl. B60W 50/14; B60W 50/02; G06V 20/56

(52) U.S. Cl. CPC B60W 50/14; B60W 50/0205; G06V 20/56; B60W 2050/021; B60W 2050/146; B60W 2420/42

(57) ABSTRACT

The present invention provides a failure diagnosis system (10) including: a vehicle-related data acquisition unit (11) acquiring vehicle-related data related to a target vehicle; a malfunction determination unit (12) determining a malfunction that may be occurring in the target vehicle, based on the vehicle-related data; an image capture location determination unit (13) determining an area to be captured for failure diagnosis, based on the determined malfunction; and a notification unit (14) notifying a user of the determined area to be captured.

### TECHNICAL FIELD

The present invention relates to a failure diagnosis system, a failure diagnosis method, and a program.

### BACKGROUND ART

Patent Document 1 discloses a technology related to the present invention. Patent Document 1 discloses a system remotely performing failure diagnosis of a vehicle. The system has a function of indicating a location an image of which is to be captured as a diagnosis target. Specifically, when an image of a certain location in a trunk needs to be captured, the system displays a captured image from a camera on a display of a user terminal and displays, by superimposition on the image, an arrow indicating the location an image of which is to be captured. Further, when a location an image of which is to be captured is out of the image capture range of a camera, the system instructs user to move the camera.

### RELATED DOCUMENT

### Patent Document

Patent Document 1: Japanese Patent Application Publication No. 2004-058777

### DISCLOSURE OF THE INVENTION

### Technical Problem

A system remotely performing failure diagnosis of a vehicle improves user convenience. However, when the system cannot acquire suitable data for failure diagnosis, precision of the diagnosis is degraded.

While Patent Document 1 discloses a technology for providing guidance on a location an image of which is to be captured for diagnosis, it is unclear how the location an image of which is to be captured is determined. Patent Document 1 does not disclose a technology for determining a location an image of which is to be captured. Naturally, without correct determination of a location an image of which is to be captured, suitable data are not acquired, and precision of diagnosis is degraded.

An object of the present invention is to improve precision of failure diagnosis in a system remotely performing failure diagnosis of a vehicle.

### Solution to Problem

The present invention provides a failure diagnosis system including:
a vehicle-related data acquisition unit that acquires vehicle-related data related to a target vehicle;
a malfunction determination unit that determines a malfunction that may be occurring in the target vehicle, based on the vehicle-related data;
an image capture location determination unit that determines an area to be captured for failure diagnosis, based on the determined malfunction; and
a notification unit that notifies a user of the determined area to be captured.

Further, the present invention provides a failure diagnosis method including, by a computer:
acquiring vehicle-related data related to a target vehicle;
determining a malfunction that may be occurring in the target vehicle, based on the vehicle-related data;
determining an area to be captured for failure diagnosis, based on the determined malfunction; and
notifying a user of the determined area to be captured.

Further, the present invention provides a program causing a computer to function as:
a vehicle-related data acquisition unit that acquires vehicle-related data related to a target vehicle;
a malfunction determination unit that determines a malfunction that may be occurring in the target vehicle, based on the vehicle-related data;
an image capture location determination unit that determines an area to be captured for failure diagnosis, based on the determined malfunction; and
a notification unit that notifies a user of the determined area to be captured.

### Advantageous Effects of Invention

The present invention improves precision of failure diagnosis in a system remotely performing failure diagnosis of a vehicle.

### BRIEF DESCRIPTION OF THE DRAWINGS

FIG. 1 is a diagram for illustrating an overall picture of a system using a failure diagnosis system according to the present example embodiment.

FIG. 2 is a diagram for illustrating an overall picture of a system using the failure diagnosis system according to the present example embodiment.

FIG. 3 is a diagram for illustrating an overall picture of a system using the failure diagnosis system according to the present example embodiment.

FIG. 4 is a diagram illustrating an example of a hardware configuration of the failure diagnosis system according to the present example embodiment.

FIG. 5 is a diagram illustrating an example of a functional block diagram of the failure diagnosis system according to the present example embodiment.

FIG. 6 is a flowchart illustrating an example of a flow of processing in the failure diagnosis system according to the present example embodiment.

FIG. 7 is a diagram illustrating an example of a functional block diagram of a failure diagnosis system according to the present example embodiment.

FIG. 8 is a flowchart illustrating an example of a flow of processing in the failure diagnosis system according to the present example embodiment.

FIG. 9 is a flowchart illustrating an example of a flow of processing in a failure diagnosis system according to the present example embodiment.

FIG. 10 is a diagram illustrating an example of a functional block diagram of a failure diagnosis system according to the present example embodiment.

FIG. 11 is a flowchart illustrating an example of a flow of processing in the failure diagnosis system according to the present example embodiment.

FIG. 12 is a flowchart illustrating an example of a flow of processing in the failure diagnosis system according to the present example embodiment.

### DESCRIPTION OF EMBODIMENTS

Example embodiments of the present invention will be described below by using drawings. Note that, in every drawing, similar components are given similar signs, and description thereof is omitted as appropriate.

### First Example Embodiment

### Overview

A failure diagnosis system according to the present example embodiment remotely performs failure diagnosis of a vehicle. Then, the failure diagnosis system has a function of determining a malfunction that may be occurring in a target vehicle (a vehicle being a target on which failure diagnosis is performed), based on vehicle-related data related to the target vehicle, determining an area to be captured for failure diagnosis, based on the determined malfunction that may be occurring, and notifying a user to capture an image of the determined area to be captured.

Thus, the failure diagnosis system according to the present example embodiment determining a malfunction that may be occurring in a target vehicle, based on vehicle-related data, and determining an area to be captured for failure diagnosis, based on the determined malfunction that may be occurring, can determine a suitable location as an area to be captured for failure diagnosis. As a result, the failure diagnosis system 10 can acquire suitable data for failure diagnosis and perform high-precision failure diagnosis.

### Overall Picture

Prior to detailed description of a configuration of the failure diagnosis system according to the present example embodiment, examples of an overall picture of a system using the failure diagnosis system will be described.

### First Example

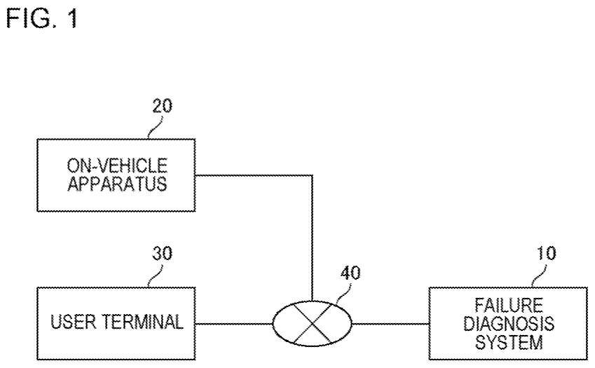

In a first example illustrated in FIG. 1, an on-vehicle apparatus 20 of a user and a user terminal 30, and the failure diagnosis system 10 can communicate with each other through a communication network 40 such as the Internet.

The on-vehicle apparatus 20 is an apparatus equipped on a vehicle. The on-vehicle apparatus 20 has a function of collecting data from various processors, such as an electronic control unit (ECU), and various sensors that are equipped on the vehicle, and a function of accepting various inputs from a user. Further, the on-vehicle apparatus 20 illustrated in FIG. 1 has a function of connecting to the communication network 40.

The user terminal 30 is a terminal apparatus possessed by a user, examples of the terminal apparatus including a smartphone, a mobile phone, a tablet terminal, a smartwatch, and a personal computer.

For example, through a preinstalled dedicated application, the on-vehicle apparatus 20 and/or the user terminal 30 provides communication with the failure diagnosis system 10 described below, information provision to a user, and acceptance of an input from the user.

An overview of a flow of processing in the first example is as follows.

The on-vehicle apparatus 20 or the user terminal 30 accepts various user inputs. For example, the on-vehicle apparatus 20 or the user terminal 30 accepts input of a failure diagnosis request. Then, in response to the input, the on-vehicle apparatus 20 or the user terminal 30 transmits the failure diagnosis request to the failure diagnosis system 10.

After accepting the failure diagnosis request, the failure diagnosis system 10 acquires vehicle-related data from the on-vehicle apparatus 20. The failure diagnosis system 10 determines an area to be captured, based on the acquired vehicle-related data. The failure diagnosis system 10 transmits an instruction to capture an image of the determined area to be captured to the on-vehicle apparatus 20 or the user terminal 30. The on-vehicle apparatus 20 or the user terminal 30 outputs (for example, displays on a display) the instruction about the area to be captured received from the failure diagnosis system 10 to the user.

Subsequently, the failure diagnosis system 10 acquires an image of the area to be captured, captured by the user from the on-vehicle apparatus 20 or the user terminal 30. For example, the user captures an image of the area to be captured, notified by the failure diagnosis system 10, by using a camera function of the user terminal 30. Then, the user transmits the image stored in the user terminal 30 to the failure diagnosis system 10, by using a communication function of the user terminal 30. In addition, the user may capture an image of the area to be captured, notified by the failure diagnosis system 10, by using any image capture apparatus (such as the user terminal 30 or a digital camera). In this case, the user inputs the captured image to the on-vehicle apparatus 20 by using any means (such as wired communication, wireless communication, or insertion of a storage medium on which the image is stored into the on-vehicle apparatus 20). Then, the on-vehicle apparatus 20 transmits the input image to the failure diagnosis system 10.

The failure diagnosis system 10 performs failure diagnosis, based on the received image. Then, the failure diagnosis system 10 transmits the failure diagnosis result to the on-vehicle apparatus 20 or the user terminal 30. The on-vehicle apparatus 20 or the user terminal 30 outputs (for example displays on a display) the failure diagnosis result received from the failure diagnosis system 10 to the user.

### Second Example

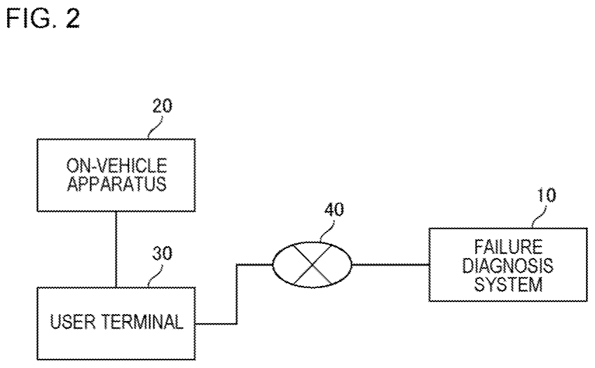

In a second example illustrated in FIG. 2, the on-vehicle apparatus 20 differs from the first example in having a function of communicating with the user terminal 30 by using any means. The on-vehicle apparatus 20 may be connected to the user terminal 30 by short-distance wireless communication or may be connected to the user terminal 30 by wired communication.

An overview of a flow of processing in the second example is as follows.

The user terminal 30 accepts various inputs from a user. For example, the user terminal 30 accepts input of a failure diagnosis request. Then, in response to the input, the user terminal 30 transmits the failure diagnosis request to the failure diagnosis system 10.

After accepting the failure diagnosis request, the failure diagnosis system 10 acquires vehicle-related data from the on-vehicle apparatus 20 through the user terminal 30. The on-vehicle apparatus 20 transmits the vehicle-related data to the user terminal 30. Then, the user terminal 30 transmits the vehicle-related data to the failure diagnosis system 10. The failure diagnosis system 10 determines an area to be captured, based on the acquired vehicle-related data. The failure diagnosis system 10 transmits an instruction to capture an image of the determined area to be captured to the user terminal 30. The user terminal 30 outputs (for example, displays on a display) the instruction about the area to be captured, received from the failure diagnosis system 10 to the user.

Subsequently, the failure diagnosis system 10 acquires an image of the area to be captured, captured by the user from the user terminal 30. For example, the user captures an image of the area to be captured, notified by the failure diagnosis system 10, by using the camera function of the user terminal 30. Then, the user transmits the image stored in the user terminal the to the failure diagnosis system 10, by using the communication function of the user terminal 30.

The failure diagnosis system 10 performs failure diagnosis, based on the received image. Then, the failure diagnosis system 10 transmits the failure diagnosis result to the user terminal 30. The user terminal 30 outputs (for example, displays on a display) the failure diagnosis result received from the failure diagnosis system 10 to the user.

### Third Example

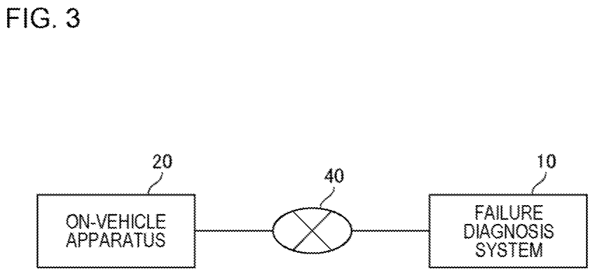

A third example illustrated in FIG. 3 differs from the first example in that the user terminal 30 is not used.

An overview of a flow of processing in the third example is as follows.

The on-vehicle apparatus 20 accepts various inputs from a user. For example, the on-vehicle apparatus 20 accepts input of a failure diagnosis request. Then, in response to the input, the on-vehicle apparatus 20 transmits the failure diagnosis request to the failure diagnosis system 10.

After accepting the failure diagnosis request, the failure diagnosis system 10 acquires vehicle-related data from the on-vehicle apparatus 20. The failure diagnosis system 10 determines an area to be captured, based on the acquired vehicle-related data. The failure diagnosis system 10 transmits an instruction to capture an image of the determined area to be captured to the on-vehicle apparatus 20. The on-vehicle apparatus 20 outputs (for example, displays on a display) the instruction about the area to be captured, received from the failure diagnosis system 10 to the user.

Subsequently, the failure diagnosis system 10 acquires an image of the area to be captured, captured by the user from the on-vehicle apparatus 20. For example, the user captures an image of the area to be captured, notified by the failure diagnosis system 10, by using any image capture apparatus (such as the user terminal 30 or a digital camera). Then, the user inputs the captured image to the on-vehicle apparatus 20 by using any means (such as wired communication, wireless communication, or insertion of a storage medium on which the image is stored into the on-vehicle apparatus 20). Then, the on-vehicle apparatus 20 transmits the input image to the failure diagnosis system 10.

The failure diagnosis system 10 performs failure diagnosis, based on the received image. Then, the failure diagnosis system 10 transmits the failure diagnosis result to the on-vehicle apparatus 20. The on-vehicle apparatus 20 outputs (for example, displays on a display) the failure diagnosis result received from the failure diagnosis system 10 to the user.

### Configuration

Next, the configuration of the failure diagnosis system 10 will be described in detail. First, an example of a hardware configuration of the failure diagnosis system 10 will be described. Each functional unit in the failure diagnosis system 10 is provided by any combination of hardware and software centered on a central processing unit (CPU), a memory, a program loaded into the memory, a storage unit storing the program such as a hard disk [capable of storing not only a program previously stored in the shipping stage of the apparatus but also a program downloaded from a storage medium such as a compact disc (CD) or a server on the Internet], and a network connection interface, the aforementioned components being included in any computer. Then, it may be understood by a person skilled in the art that various modifications to the providing method and the apparatus can be made.

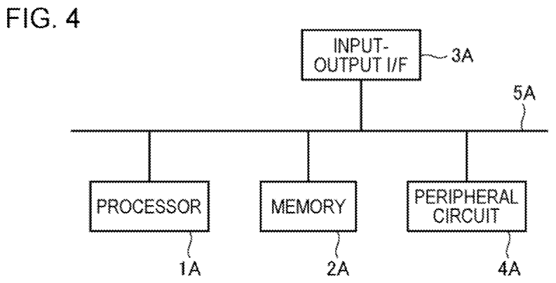

FIG. 4 is a block diagram illustrating the hardware configuration of the failure diagnosis system 10. As illustrated in FIG. 4, the failure diagnosis system 10 includes a processor 1A, a memory 2A, an input-output interface 3A, a peripheral circuit 4A, and a bus 5A. Various modules are included in the peripheral circuit 4A. The failure diagnosis system 10 may not include the peripheral circuit 4A. Note that the failure diagnosis system 10 may be configured with a plurality of physically and/or logically separate apparatuses or may be configured with one physically and/or logically integrated apparatus. When the failure diagnosis system 10 is configured with a plurality of physically and/or logically separate apparatuses, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, a camera, and the like, and an interface for outputting Information to an output apparatus, the external apparatus, the external server, and the like. Examples of the input apparatus include a keyboard, a mouse, a microphone, a physical button, and a touch panel. Examples of the output apparatus include a display, a speaker, a printer, and a mailer. The processor 1A can issue an instruction to each module and perform an operation, based on the operation result by the module.

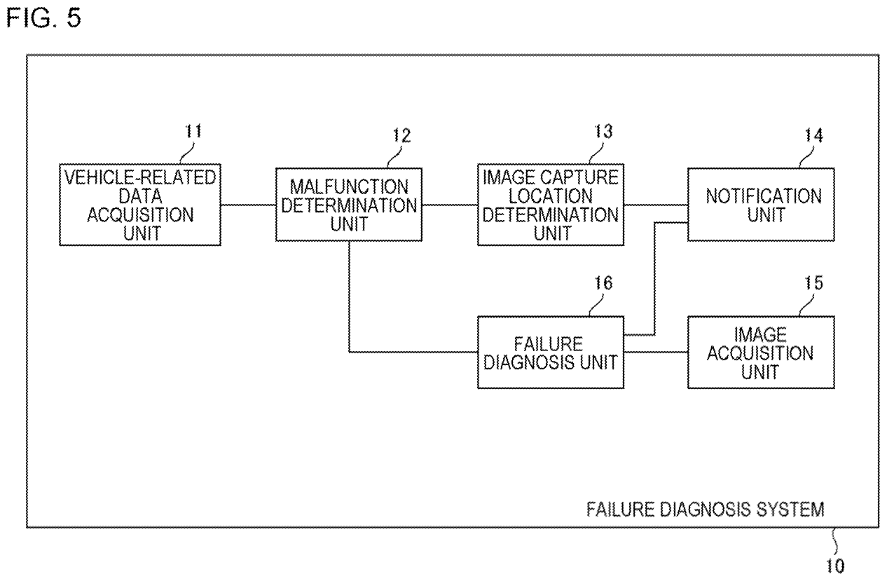

Next, a functional configuration of the failure diagnosis system 10 will be described. FIG. 5 illustrates an example of a functional block diagram of the failure diagnosis system 10. As illustrated, the failure diagnosis system 10 includes a vehicle-related data acquisition unit 11, a malfunction determination unit 12, an image capture location determination unit 13, a notification unit 14, an image acquisition unit 15, and a failure diagnosis unit 16.

The vehicle-related data acquisition unit 11 acquires vehicle-related data related to a target vehicle.

A “target vehicle” is a vehicle being a target on which failure diagnosis is performed. For example, a user being the owner of a vehicle makes a failure diagnosis request at any timing when failure diagnosis is desired such as when some symptom is occurring in the vehicle or at a timing when a predetermined period has elapsed from a previous inspection. For example, the request is provided by a predetermined operation through the on-vehicle apparatus 20 or the user terminal 30. In response to the operation, the failure diagnosis request is transmitted to the failure diagnosis system 10 from the on-vehicle apparatus 20 or the user terminal 30.

“Vehicle-related data” are data collected from various processors, such as an ECU, and various sensors, the processors and the sensors being equipped on a vehicle. Examples of such data include internal voltage, engine speed, internal pressure in a crankcase, and data generated by a sensor measuring a travel distance or the like, a microphone picking up sound, and the like. Further, examples of such data also include a history of a diagnostic trouble code (DTC) (a history of a detected data abnormality). Note that the vehicle-related data acquisition unit 11 may acquire part or all of the vehicle-related data exemplified above or may acquire vehicle-related data not exemplified above.

The vehicle-related data acquisition unit 11 acquires vehicle-related data for a past predetermined period in response to a failure diagnosis request. The length of the predetermined period is a matter of design.

The vehicle-related data acquisition unit 11 may acquire vehicle-related data stored in the on-vehicle apparatus 20 at that point in time from the on-vehicle apparatus 20 or the user terminal 30, in response to a failure diagnosis request. In addition, vehicle-related data may be regularly or irregularly transmitted (uploaded) to the failure diagnosis system 10 from the on-vehicle apparatus 20 or the user terminal 30 and be accumulated in the failure diagnosis system 10 regardless of existence of a failure diagnosis request. Then, the vehicle-related data acquisition unit 11 may acquire vehicle-related data stored in the failure diagnosis system 10 at that point in time in response to a failure diagnosis request.

Next, the malfunction determination unit 12 determines a malfunction that may be occurring in the target vehicle, based on the vehicle-related data. Specifically, the malfunction determination unit 12 detects a data abnormality indicating a behavior different from that under normal operation, based on the vehicle-related data. Then, the malfunction determination unit 12 determines a malfunction that may be occurring, based on content of the detected data abnormality.

First, examples of processing of detecting a data abnormality will be described.

### First Example

When a history of a DTC code (a history of a data abnormality detected from vehicle-related data) is included in the vehicle-related data, the malfunction determination unit 12 may detect a data abnormality indicated by the history (detected data abnormality) as an occurring data abnormality.

### Second Example

The malfunction determination unit 12 analyzes vehicle-related data and detects a data abnormality. Examples of a data abnormality detection technique to be considered include a first technique of preregistering a behavior under normal operation and detecting a behavior different from the registered behavior in the data, a second technique of preregistering a behavior different from that under normal operation and detecting the registered behavior in the data, and a third technique of combining the first technique and the second technique. The malfunction determination unit 12 may provide detection by any of the techniques. Further, the malfunction determination unit 12 may provide detection of a data abnormality by another well-known technique.

Next, examples of processing of determining a malfunction that may be occurring, based on content of a detected data abnormality, will be described.

### First Example

An estimation model estimating, from an occurring data abnormality, a malfunction causing the data abnormality by machine learning based on training data in which an occurring data abnormality (one abnormality or a combination of a plurality of abnormalities) is associated with a malfunction causing the data abnormality is previously generated. Then, the malfunction determination unit 12 determines a malfunction that may be occurring, based on the estimation model and content of a detected data abnormality.

### Second Example

Abnormality-malfunction relation information in which an occurring data abnormality (one abnormality or a combination of a plurality of abnormalities) is associated with a malfunction causing the data abnormality is previously prepared and is stored in the failure diagnosis system 10. Then, the malfunction determination unit 12 determines a malfunction that may be occurring, based on the abnormality-malfunction relation information and content of a detected data abnormality. An example of information included in the abnormality-malfunction relation information is described below.

TABLE 1

| Data abnormality | Malfunction |
|---|---|
| Stoppage of internal voltage and | Battery exhaustion |
| occurrence of unusual sound | |
| Sudden rise/fall of engine speed | Hunting |
| Rise of internal pressure in crankcase and | Malfunction of positive crankcase |
| occurrence of unusual sound | ventilation system |
| . | . |
| . | . |
| . | . |
| . | . |

Next, the image capture location determination unit 13 determines an area to be captured for failure diagnosis, based on the determined malfunction that may be occurring. Malfunction-inspection-location relation information in which a malfunction is associated with a location to be inspected when the malfunction occurs is previously prepared and is stored in the failure diagnosis system 10. Then, the image capture location determination unit 13 determines a location to be inspected, based on the malfunction-inspection-location relation information and the determined malfunction that may be occurring, and determines the determined location as an area to be captured. An example of information included in the malfunction-inspection-location relation information is described below.

TABLE 2

| Abnormality | Inspection location |
|---|---|
| Battery exhaustion | Liquid level of each tank in battery, battery |
| | terminal, electric wiring |
| Hunting | Air duct hose in engine room, intake |
| | manifold |
| Malfunction of positive crankcase | Blowby hose in engine room, clamp, |
| ventilation system | positive crankcase ventilation (PCV) valve |
| . | . |
| . | . |
| . | . |
| . | . |

Next, the notification unit 14 notifies the user of the area to be captured, determined by the image capture location determination unit 13. The notification is provided through the on-vehicle apparatus 20 of the user or the user terminal 30.

Next, after the notification by the notification unit 14, the image acquisition unit 15 acquires an image in which the area to be captured in the target vehicle is captured from an external apparatus (the on-vehicle apparatus 20 or the user terminal 30).

Next, the failure diagnosis unit 16 analyzes the image acquired by the image acquisition unit 15 and performs failure diagnosis of the target vehicle. By the failure diagnosis performed by the failure diagnosis unit 16, whether the malfunction that may be occurring determined by the malfunction determination unit 12 is actually occurring is determined.

An algorithm of failure diagnosis by image analysis is defined for each malfunction that may be occurring and each area to be captured. The failure diagnosis unit 16 analyzes an image by an algorithm based on a malfunction determined by the malfunction determination unit 12 and an area to be captured, determined by the image capture location determination unit 13 and performs failure diagnosis. Details of the algorithm is a matter of design and can be provided by employing every well-known technology. For example, an estimation model determining occurrence of a malfunction by machine learning with an image before occurrence of a malfunction and an image at the time of occurrence of a malfunction as training data may be previously generated. Then, failure diagnosis may be performed by using the estimation model.

Note that when determining that a malfunction that may be occurring determined by the malfunction determination unit 12 is actually occurring, the failure diagnosis unit 16 may further determine whether the malfunction is a malfunction that can be handled by the user himself/herself. For example, a list of malfunctions that can be handled by the user himself/herself is previously generated and is stored in the failure diagnosis system 10. Then, the failure diagnosis unit 16 determines whether the malfunction is a malfunction that can be handled by the user himself/herself by determining whether the malfunction is registered in the list. Then, when the malfunction is a malfunction that can be handled by the user himself/herself, the failure diagnosis unit 16 may pick out information indicating a method for handling the malfunction and being previously stored in the failure diagnosis system 10.

The aforementioned notification unit 14 can notify the user of the diagnosis result by the failure diagnosis unit 16. The notification is provided through the on-vehicle apparatus 20 of the user or the user terminal 30.

When the failure diagnosis unit 16 determines that the malfunction that may be occurring determined by the malfunction determination unit 12 is actually occurring, the notification unit 14 notifies the user, as a diagnosis result, that the malfunction is occurring. Further, when the malfunction is a malfunction that can be handled by the user himself/herself, the notification unit 14 may notify the user of information indicating a method for handling the malfunction. On the other hand, when the malfunction is not a malfunction that can be handled by the user himself/herself, the notification unit 14 may make notification to that effect and may further make notification prompting contact with a dealer or a repair shop.

When the failure diagnosis unit 16 determines that the malfunction that may be occurring determined by the malfunction determination unit 12 is not occurring, the notification unit 14 makes notification to that effect to the user as a diagnosis result.

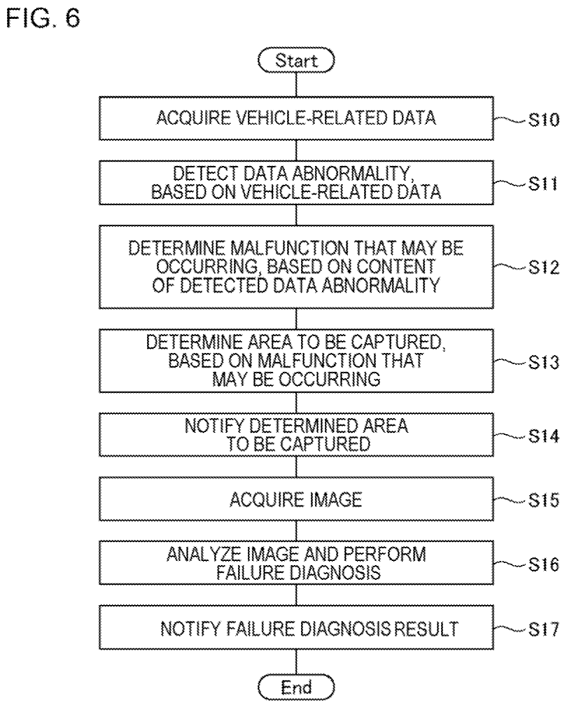

Next, an example of a flow of processing in the failure diagnosis system 10 will be described by using a flowchart in FIG. 6. When acquiring a failure diagnosis request from the on-vehicle apparatus 20 or the user terminal 30, the failure diagnosis system 10 executes processing described in the flowchart in FIG. 6 in response to the request. Note that the intention here is to describe a flow of the processing. Since details of each type of processing are described above, description thereof is omitted here.

First, the vehicle-related data acquisition unit 11 acquires vehicle-related data of a target vehicle (S10). Next, based on the acquired vehicle-related data, the malfunction determination unit 12 detects a data abnormality indicating a behavior different from that under normal operation (S11). Next, based on content of the detected data abnormality, the malfunction determination unit 12 determines a malfunction that may be occurring in the target vehicle (S12).

Next, based on the malfunction that may be occurring, the image capture location determination unit 13 determines an area to be captured for failure diagnosis (S13). Then, the notification unit 14 notifies a user of the determined area to be captured (S14).

Subsequently, the image acquisition unit 15 acquires an image in which the area to be captured in the target vehicle is captured (S15). Next, the failure diagnosis unit 16 analyzes the acquired image and performs failure diagnosis of the target vehicle (S16). Then, the notification unit 14 notifies the user of the result of the failure diagnosis (S17).

### Advantageous Effects

The failure diagnosis system 10 determines a malfunction that may be occurring in a target vehicle, based on vehicle-related data, and determines an area to be captured for failure diagnosis, based on the determined malfunction. More specifically, the failure diagnosis system 10 detects a data abnormality occurring in the target vehicle, based on the vehicle-related data, determines a malfunction that may be occurring, based on the detected data abnormality, and determines an area to be captured for failure diagnosis, based on the determined malfunction.

Such a failure diagnosis system 10 can determine a suitable location as an area to be captured for failure diagnosis. As a result, the failure diagnosis system 10 can acquire suitable data for failure diagnosis and perform high-precision failure diagnosis.

### Second Example Embodiment

A failure diagnosis system 10 according to the present example embodiment differs from that according to the first example embodiment in having a function of acquiring “symptom information indicating a symptom occurring in a target vehicle” input by a user and determining vehicle-related data being a target of data abnormality detection, based on the symptom information. Details will be described below.

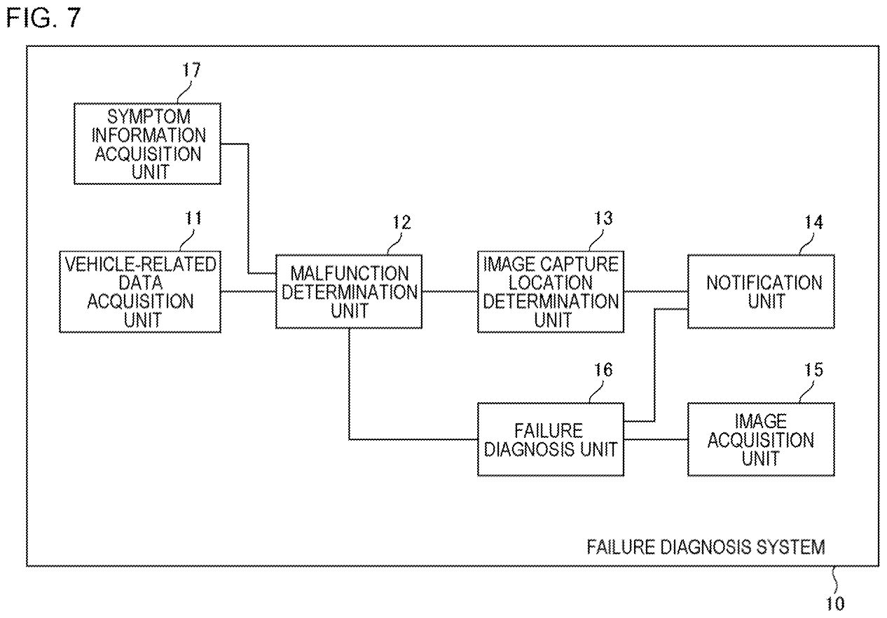

FIG. 7 illustrates an example of a functional block diagram of the failure diagnosis system 10 according to the present example embodiment. As illustrated, the failure diagnosis system 10 differs from that according to the first example embodiment in including a symptom information acquisition unit 17.

The symptom information acquisition unit 17 acquires symptom information indicating a symptom occurring in a target vehicle. The symptom information acquisition unit 17 acquires, from an on-vehicle apparatus 20 or a user terminal 30, symptom information generated based on user input through the on-vehicle apparatus 20 or the user terminal 30.

Examples of a symptom indicated by symptom information include “the engine does not start,” “the driving sound of the motor is weak,” “the engine sound suddenly increases or decreases,” “the accelerator does not work well,” and “white smoke occurs” but are not limited thereto. For example, the symptom information acquisition unit 17 may selectably provide a user with a plurality of symptoms as described above preregistered in the failure diagnosis system 10 and acquire symptom information indicating a symptom selected from the symptoms.

A malfunction determination unit 12 determines vehicle-related data being a target of data abnormality detection from a plurality of types of vehicle-related data acquired by a vehicle-related data acquisition unit 11, based on the symptom information acquired by the symptom information acquisition unit 17. Symptom-analysis-target relation information in which an occurring symptom (one abnormality or a combination of a plurality of abnormalities) is associated with vehicle-related data to be analyzed when the symptom occurs is previously prepared and is stored in the failure diagnosis system 10. Then, the malfunction determination unit 12 determines vehicle-related data to be analyzed, based on the symptom-analysis-target relation information and a symptom indicated by the acquired symptom information. An example of information included in the symptom-analysis-target relation information is described below.

TABLE 3

| Symptom | Analysis target |
|---|---|
| Engine does not start, and driving sound of | Internal voltage and |
| motor is weak | generated sound |
| Engine sound suddenly increases or | Engine speed |
| decreases | |
| Accelerator does not work well, and white | Internal pressure in crankcase |
| smoke occurs | and generated sound |
| . | . |
| . | . |
| . | . |
| . | . |

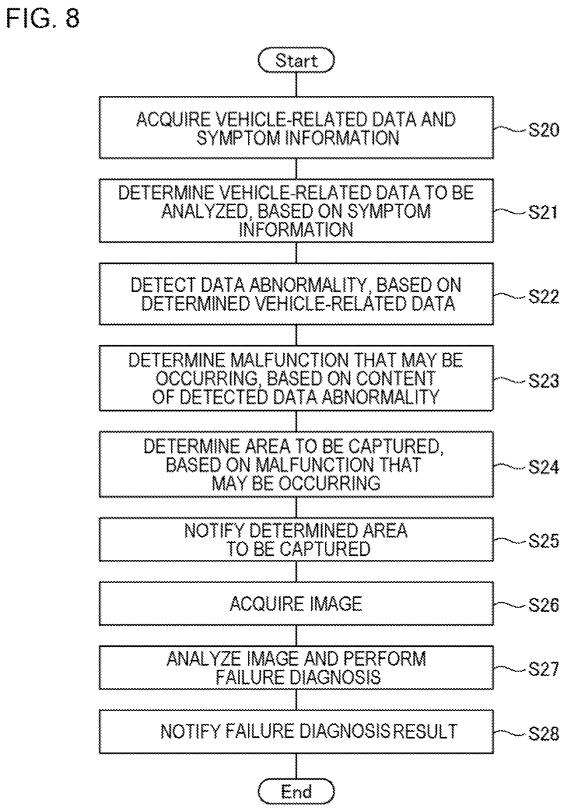

Next, an example of a flow of processing in the failure diagnosis system 10 will be described by using a flowchart in FIG. 8. When acquiring a failure diagnosis request from the on-vehicle apparatus 20 or the user terminal 30, the failure diagnosis system 10 executes processing described in the flowchart in FIG. 8 in response to the request. Note that the intention here is to describe a flow of the processing. Since details of each type of processing are described above, description thereof is omitted here.

First, the vehicle-related data acquisition unit 11 acquires vehicle-related data of a target vehicle, and the symptom information acquisition unit 17 acquires symptom information (S20). Next, based on the symptom information, the malfunction determination unit 12 determines vehicle-related data being a target of data abnormality detection from a plurality of types of vehicle-related data acquired by the vehicle-related data acquisition unit 11 (S21). Next, based on the acquired vehicle-related data, the malfunction determination unit 12 detects a data abnormality of the vehicle-related data determined as a target of data abnormality detection (S22). Next, based on content of the detected data abnormality, the malfunction determination unit 12 determines a malfunction that may be occurring in the target vehicle (S23).

Next, based on the malfunction that may be occurring, the image capture location determination unit 13 determines an area to be captured for failure diagnosis (S24). Then, the notification unit 14 notifies the user of the determined area to be captured (S25).

Subsequently, the image acquisition unit 15 acquires an image in which the area to be captured in the target vehicle is captured (S26). Next, the failure diagnosis unit 16 analyzes the acquired image and performs failure diagnosis of the target vehicle (S27). Then, the notification unit 14 notifies the user of the result of the failure diagnosis (S28).

The remaining configuration of the failure diagnosis system 10 and an overall picture of a system using the failure diagnosis system 10 are similar to those according to the first example embodiment.

As described above, the failure diagnosis system 10 according to the present example embodiment provides advantageous effects similar to those of the first example embodiment. Further, the failure diagnosis system 10 according to the present example embodiment can narrow down vehicle-related data to be analyzed, based on a symptom recognized by a user. As a result, the processing burden of the failure diagnosis system 10 can be lightened. Further, failure diagnosis system 10 can perform high-precision failure diagnosis.

### Third Example Embodiment

Data abnormalities of vehicle-related data include an abnormality directly due to a malfunction occurring in a vehicle and an abnormality occurring due to another data abnormality, that is, an abnormality indirectly due to a malfunction occurring in the vehicle. A failure diagnosis system 10 according to the present example embodiment differs from those according to the first and second example embodiments in having a function of, when a plurality of types of data abnormalities are detected, excluding a data abnormality occurring due to occurrence of another data abnormality from the detected data abnormalities and determining a malfunction that may be occurring, based on content of an unexcluded data abnormality. Details will be described below.

An example of a functional block diagram of the failure diagnosis system 10 according to the present example embodiment is illustrated in FIG. 5 or FIG. 7.

When a plurality of types of data abnormalities are detected, a malfunction determination unit 12 excludes a data abnormality occurring due to occurrence of another data abnormality from the detected data abnormalities. Then, the malfunction determination unit 12 determines a malfunction, based on content of an unexcluded data abnormality in the detected data abnormalities.

Processing of detecting a data abnormality occurring due to occurrence of another data abnormality from detected data abnormalities will be described.

### First Example

A model learning data related to a past malfunction (such as an output DTC, an output source ECU, warning light data, and travel data before and after DTC output) by machine learning and estimating a DTC directly due to a malfunction occurring in a vehicle is previously generated and is stored in the failure diagnosis system 10. The malfunction determination unit 12 estimates a DTC directly due to a malfunction occurring in a vehicle, based on the model and a plurality of types of detected data abnormalities. Then, the malfunction determination unit 12 detects the other data abnormalities as data abnormalities occurring due to occurrence of other data abnormalities.

### Second Example

Data abnormality chain information indicating relationship between a certain data abnormality and a data abnormality occurring due to occurrence of the data abnormality is previously prepared and is stored in the failure diagnosis system 10. Then, the malfunction determination unit 12 detects a data abnormality occurring due to occurrence of another data abnormality, based on the data abnormality chain information and a plurality of types of detected data abnormalities.

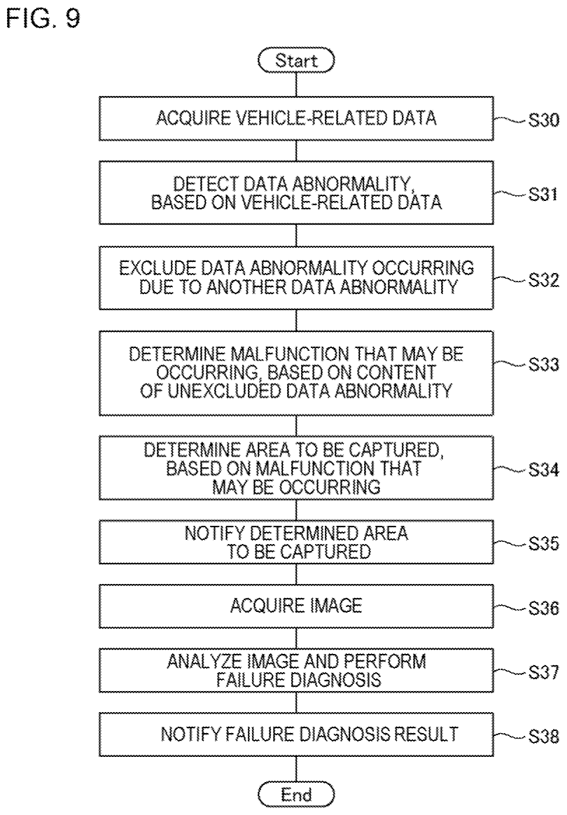

Next, an example of a flow of processing in the failure diagnosis system 10 will be described by using a flowchart in FIG. 9. When acquiring a failure diagnosis request from an on-vehicle apparatus 20 or a user terminal 30, the failure diagnosis system 10 executes processing described in the flowchart in FIG. 9 in response to the request. Note that the intention here is to describe a flow of the processing. Since details of each type of processing are described above, description thereof is omitted here.

First, a vehicle-related data acquisition unit 11 acquires vehicle-related data of a target vehicle (S30). Next, based on the acquired vehicle-related data, the malfunction determination unit 12 detects a data abnormality indicating a behavior different from that under normal operation (S31). Next, the malfunction determination unit 12 excludes a data abnormality occurring due to occurrence of another data abnormality from a plurality of types of detected data abnormalities (S32). Next, based on content of an unexcluded data abnormality in the detected data abnormalities, the malfunction determination unit 12 determines a malfunction that may be occurring in the target vehicle (S33).

Next, based on the malfunction that may be occurring, the image capture location determination unit 13 determines an area to be captured for failure diagnosis (S34). Then, the notification unit 14 notifies a user of the determined area to be captured (S35).

Subsequently, an image acquisition unit 15 acquires an image in which the area to be captured in the target vehicle is captured (S36). Next, a failure diagnosis unit 16 analyzes the acquired image and performs failure diagnosis of the target vehicle (S37). Then, the notification unit 14 notifies the user of the result of the failure diagnosis (S38).

Note that while not being described in the example, the failure diagnosis system 10 may execute processing of acquiring symptom information and determining vehicle-related data to be analyzed, based on the symptom information, similarly to the second example embodiment.

The remaining configuration of the failure diagnosis system 10 and an overall picture of a system using the failure diagnosis system 10 are similar to those according to the first and second example embodiments.

As described above, the failure diagnosis system 10 according to the present example embodiment provides advantageous effects similar to those of the first and second example embodiments. Further, when a plurality of types of data abnormalities are detected, the failure diagnosis system 10 according to the present example embodiment can exclude a data abnormality occurring due to occurrence of another data abnormality from the detected data abnormalities. Then, the failure diagnosis system 10 according to the present example embodiment can determine a malfunction that may be occurring in a target vehicle, based on an unexcluded data abnormality in the detected data abnormalities, that is, a data abnormality directly due to a malfunction occurring in the target vehicle. Therefore, the failure diagnosis system 10 can determine a malfunction that may be occurring in the target vehicle with high precision and perform high-precision failure diagnosis.

### Fourth Example Embodiment

A failure diagnosis system 10 according to the present example embodiment differs from the first to third example embodiments in having a function of generating guidance information for a user to suitably capture an image of an area to be captured and providing the information to the user. Details will be described below.

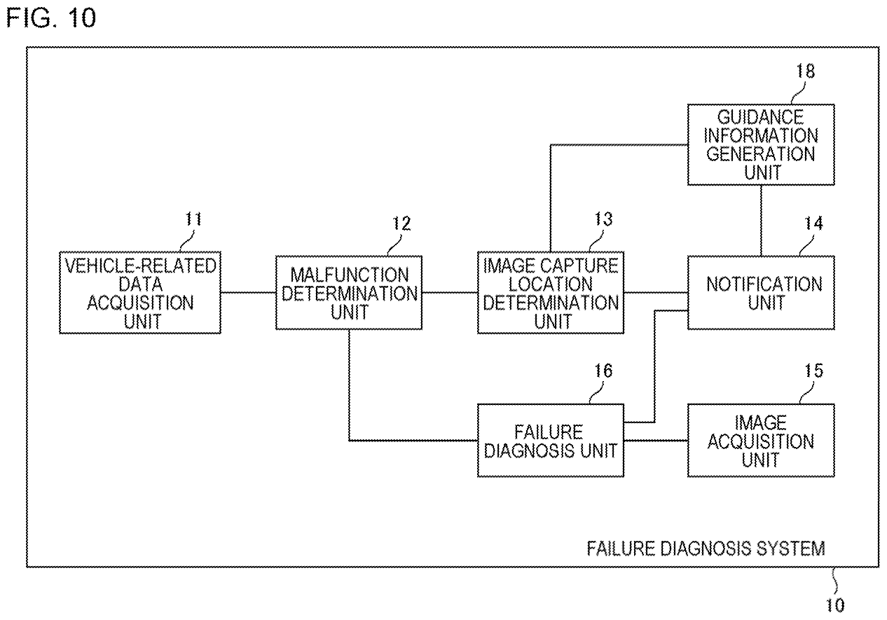

FIG. 10 illustrates an example of a functional block diagram of the failure diagnosis system 10 according to the present example embodiment. As illustrated, the failure diagnosis system 10 differs from those according to the first to third example embodiments in including a guidance information generation unit 18. Note that while not being illustrated, the failure diagnosis system 10 may include a symptom information acquisition unit 17.

The guidance information generation unit 18 generates guidance information providing guidance on at least one of the image capture angle and the distance to a subject when an image of an area to be captured, determined by an image capture location determination unit 13 is captured. Then, a notification unit 14 notifies a user of the guidance information generated by the guidance information generation unit 18.

The guidance information generation unit 18 can generate guidance information varied for each area to be captured. Specifically, the guidance information generation unit 18 generates guidance information related to an area to be captured, determined by the image capture location determination unit 13 every time an area to be captured is determined by the image capture location determination unit 13. Generation processing of guidance information will be described below.

### First Example

In a first example, the guidance information generation unit 18 generates guidance information including a sample image. A sample image generated by suitably capturing an image of each of a plurality of areas to be captured that may be determined by the image capture location determination unit 13, that is, a sample image generated by capturing an image at a suitable image capture angle and at a suitable distance to a subject is previously generated and is stored in the failure diagnosis system 10. The guidance information generation unit 18 reads a sample image related to an area to be captured, determined by the image capture location determination unit 13 and generates guidance information including the sample image.

Note that a sample image may be generated for each predetermined group such as for each brand, for each model, for each type, or for each manufacturer. Then, the guidance information generation unit 18 may read a sample image of an area to be captured in a group to which a target vehicle belongs and generate guidance information including the sample image. The brand, the model, the type, the manufacturer, and the like of a target vehicle may be previously registered in the failure diagnosis system 10. In addition, in response to transmission of a failure diagnosis request to the failure diagnosis system 10, an on-vehicle apparatus 20 or a user terminal 30 may accept a user input specifying the aforementioned information and transmit the input content to the failure diagnosis system 10. Further, images captured by a [0] skilled mechanic may be previously accumulated, and a sample image may be selected from the images.

In the example, the user can recognize the image capture angle or the distance to a subject when capturing an image of an area to be captured by checking a sample image.

### Second Example

In a second example, the guidance information generation unit 18 analyzes an image including an area to be captured and being generated by a user and generates guidance information providing guidance on a correction for at least one of the image capture angle and the distance to a subject.

For example, the guidance information generation unit 18 detects a predetermined subject (a target an image of which is to be captured) in an image. Then, when the size (the occupied area in the image) of the subject in the image is less than a first reference value, the guidance information generation unit 18 generates guidance information providing guidance on a correction of getting closer to the subject. On the other hand, when the size (the occupied area in the image) of the subject in the image is greater than a second reference value, the guidance information generation unit 18 generates guidance information providing guidance on a correction of moving away from the subject.

Further, the guidance information generation unit 18 estimates an image capture angle, based on the shape (the shape captured in an image) or the like of a detected subject. Then, when the estimated image capture angle does not fall within a preset suitable range, the guidance information generation unit 18 generates guidance information providing guidance on a correction for the image capture angle.

Note that an estimation model learning a suitable image capture angle and a suitable distance to a subject by machine learning with the aforementioned sample image as learning data may be previously generated. Then, by using the estimation model, the guidance information generation unit 18 may determine whether a content to be corrected exists in an image generated by a user and determine the correction content.

Further, support for a user to be able to capture an image at a suitable image capture angle and at a suitable distance to a subject may be provided through a camera application (in coordination with an application dedicated to the failure diagnosis system 10) installed on the user terminal 30.

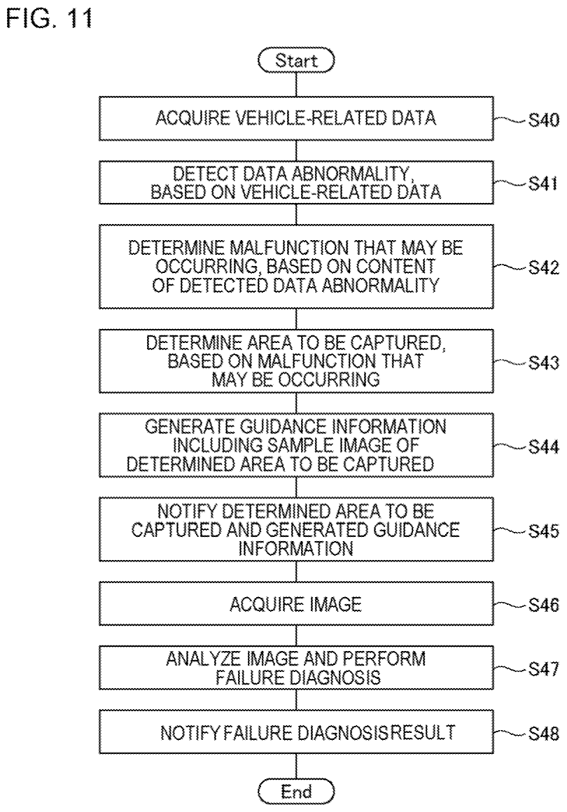

Next, an example of a flow of processing in the failure diagnosis system 10 will be described by using a flowchart in FIG. 11. When acquiring a failure diagnosis request from the on-vehicle apparatus 20 or the user terminal 30, the failure diagnosis system 10 executes processing described in the flowchart in FIG. 11 in response to the request. Note that the intention here is to describe a flow of the processing. Since details of each type of processing are described above, description thereof is omitted here.

First, a vehicle-related data acquisition unit 11 acquires vehicle-related data of a target vehicle (S40). Next, based on the acquired vehicle-related data, a malfunction determination unit 12 detects a data abnormality indicating a behavior different from that under normal operation (S41). Next, based on content of the detected data abnormality, the malfunction determination unit 12 determines a malfunction that may be occurring in the target vehicle (S42).

Next, based on the malfunction that may be occurring, the image capture location determination unit 13 determines an area to be captured for failure diagnosis (S43). Next, the guidance information generation unit 18 generates guidance information including a sample image of the determined area to be captured (S44). Then, the notification unit 14 notifies a user of the determined area to be captured and provides the user with the generated guidance information (S45).

Subsequently, an image acquisition unit 15 acquires an image in which the area to be captured in the target vehicle is captured (S46). Next, a failure diagnosis unit 16 analyzes the acquired image and performs failure diagnosis of the target vehicle (S47). Then, the notification unit 14 notifies the user of the result of the failure diagnosis (S48).

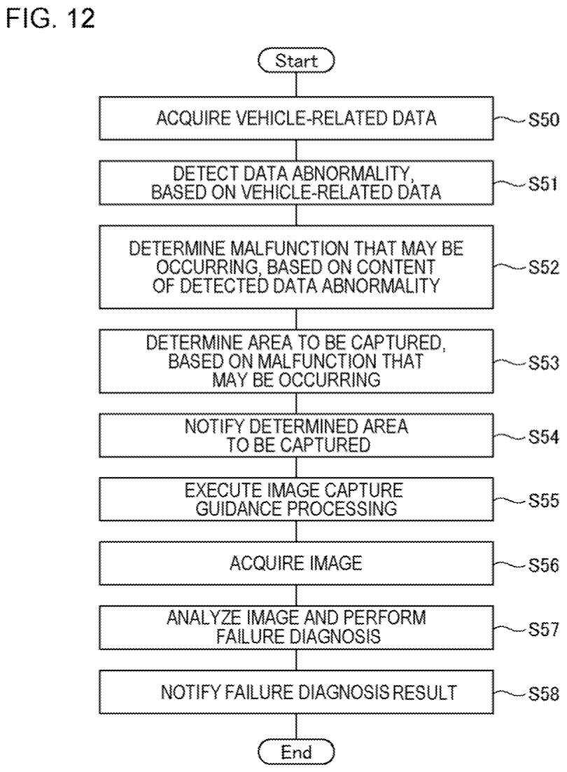

Next, an example of a flow of processing in the failure diagnosis system 10 will be described by using a flowchart in FIG. 12. When acquiring a failure diagnosis request from the on-vehicle apparatus 20 or the user terminal 30, the failure diagnosis system 10 executes processing described in the flowchart in FIG. 12 in response to the request. Note that the intention here is to describe a flow of the processing. Since details of each type of processing are described above, description thereof is omitted here.

First, the vehicle-related data acquisition unit 11 acquires vehicle-related data of a target vehicle (S50). Next, based on the acquired vehicle-related data, the malfunction determination unit 12 detects a data abnormality indicating a behavior different from that under normal operation (S51). Next, based on content of the detected data abnormality, the malfunction determination unit 12 determines a malfunction that may be occurring in the target vehicle (S52).

Next, based on the malfunction that may be occurring, the image capture location determination unit 13 determines an area to be captured for failure diagnosis (S53). Then, the notification unit 14 notifies a user of the determined area to be captured (S54).

Subsequently, image capture guidance processing by the guidance information generation unit 18 is executed (S55). For example, an image displayed on a finder of a camera application on the user terminal 30 (an image displayed on a display) is repeatedly transmitted from the user terminal 30 to the failure diagnosis system 10. The guidance information generation unit 18 analyzes the image and determines whether a correction for at least one of the image capture angle and the distance to a subject is necessary. Then, when a correction is determined to be necessary, the guidance information generation unit 18 generates guidance information indicating a correction content and transmits the information to the user terminal 30. The user terminal 30 displays the correction content indicated by the received guidance information on a display. The user changes the image capture angle and/or the distance to the subject, based on the display content. The image displayed on the finder changes according to the change. Then, the determination result by the guidance information generation unit 18 also changes. For example, the user performs an operation of capturing an image of an image capture target after notification of a correction content no longer exists. Note that in order to eliminate the need for repeated transmission of an image from the user terminal 30 to the failure diagnosis system 10, at least part of the functions of the guidance information generation unit 18 may be equipped on the user terminal 30, and determination about necessity for correction for at least one of the image capture angle and the distance to a subject, generation of guidance information indicating a correction content, and the like may be performed on the user terminal 30 side.

Subsequently, the image acquisition unit 15 acquires an image in which an image of the area to be captured in the target vehicle is captured (S56). Next, the failure diagnosis unit 16 analyzes the acquired image and performs failure diagnosis of the target vehicle (S57). Then, the notification unit 14 notifies the user of the result of the failure diagnosis (S58).

Note that while not being described in the examples in FIG. 11 and FIG. 12, the failure diagnosis system 10 may execute processing of acquiring symptom information and determining vehicle-related data to be analyzed, based on the symptom information, similarly to the second example embodiment. Further, while not being described in the example, the failure diagnosis system 10 may exclude a data abnormality occurring due to occurrence of another data abnormality from a plurality of types of detected data abnormalities and determine a malfunction that may be occurring, based on an unexcluded data abnormality.

The remaining configuration of the failure diagnosis system 10 and an overall picture of a system using the failure diagnosis system 10 are similar to those according to the first to third example embodiments.

As described above, the failure diagnosis system 10 according to the present example embodiment provides advantageous effects similar to those provided by the first to third example embodiments. Further, the failure diagnosis system 10 according to the present example embodiment can generate guidance information providing guidance on at least one of the image capture angle and the distance to a subject when an image of an area to be captured is captured and provide a user with the information. Such a failure diagnosis system 10 enables the user to suitably capture an image of an area to be captured. As a result, the failure diagnosis system 10 can acquire suitable data for failure diagnosis and perform high-precision failure diagnosis.

### Modified Examples

### First Modified Example

The first to fourth example embodiments are based on the premise that a series of processing operations described in FIGS. 6, 8, 9, 11, and 12 is executed in response to user input of a failure diagnosis request. As a modified example, the series of processing operations described in FIGS. 6, 8, 9, 11, and 12 may be executed without user input of a failure diagnosis request.

For example, the failure diagnosis system 10 may monitor the amount of time elapsed from a previous failure diagnosis for each vehicle of each user. Then, the failure diagnosis system 10 may execute the series of processing operations described in FIGS. 6, 8, 9, 11, and 12 in response to the elapsed time reaching a reference time.

In addition, the failure diagnosis system 10 may monitor the travel distance for each vehicle of each user. Then, the failure diagnosis system 10 may execute the series of processing operations described in FIGS. 6, 8, 9, 11, and 12 in response to the travel distance reaching a reference distance.

Note that in a case of failure diagnosis at the timing, the malfunction determination unit 12 may determine malfunctions that may occur according to use of a vehicle such as a worn tire, a loosened wheel nut, a decreased volume of engine oil, and dirty engine oil as malfunctions that may be occurring, in addition to malfunctions that may be occurring determined by the aforementioned technique. Such malfunctions that may occur according to use of a vehicle is previously registered. Then, in the case of failure diagnosis at the timing, the malfunction determination unit 12 reads the aforementioned previously registered malfunction and determines the malfunction as a malfunction that may be occurring.

Advantageous effects similar to those provided by the first to fifth example embodiments are also provided in the modified example. Further, failure diagnosis can be performed regularly as well as at a timing when a user makes a failure diagnosis request, and therefore, a malfunction of a vehicle can be detected early (before some symptom occurs).

### Second Modified Example

The first to fourth example embodiments are based on the premise that vehicle-related data are transmitted from the on-vehicle apparatus 20 or 30 to the failure diagnosis system 10. As a modified example, vehicle-related data may be regularly or irregularly uploaded from the on-vehicle apparatus 20 or the user terminal 30 to any server and be accumulated. Then, the failure diagnosis system 10 may acquire vehicle-related data of a target vehicle from the server. Advantageous effects similar to those provided by the first to fifth example embodiments are also provided in the modified example.

### Third Modified Example

The first to fourth example embodiments are based on the premise that the failure diagnosis system 10 includes the failure diagnosis unit 16. As a modified example, the failure diagnosis system 10 may not include the failure diagnosis unit 16. In this case, the failure diagnosis system 10 provides (for example, displays on a display or transmits to an operator terminal) an image acquired by the image acquisition unit 15 to an operator. The operator performs failure diagnosis, based on the provided image, and inputs the result to the failure diagnosis system 10. The input of the result to the failure diagnosis system 10 may be provided by inputting the result through an input apparatus in the failure diagnosis system 10. In addition, the input may be provided by performing an operation of inputting the result to an operator terminal and then transmitting the input result from the terminal to the failure diagnosis system 10. Then, the failure diagnosis system 10 provides the failure diagnosis result input by the operator to the user through the on-vehicle apparatus 20 or the user terminal 30. Advantageous effects similar to those provided by the first to fifth example embodiments are also provided in the modified example.

While the example embodiments of the present invention have been described above with reference to the drawings, the example embodiments are exemplifications of the present invention, and various configurations other than those described above may be employed.

Note that “acquisition” herein includes at least one item out of “an apparatus getting data stored in another apparatus or a storage medium (active acquisition)” such as making a request or an inquiry to another apparatus and receiving a response and readout by accessing another apparatus or a storage medium, in accordance with a user input or a program instruction, or “an apparatus inputting data output from another apparatus to the apparatus (passive acquisition)” such as reception of distributed (or, for example, transmitted or push notified) data and selective acquisition from received data or information, in accordance with a user input or a program instruction, and “generation of new data by data editing (such as conversion to text, data rearrangement, partial data extraction, or file format change) and acquisition of the new data.”.

The whole or part of the example embodiments disclosed above may also be described as, but not limited to, the following supplementary notes.
1. A failure diagnosis system including:
   a vehicle-related data acquisition unit that acquires vehicle-related data related to a target vehicle;
   a malfunction determination unit that determines a malfunction that may be occurring in the target vehicle, based on the vehicle-related data;
   an image capture location determination unit that determines an area to be captured for failure diagnosis, based on the determined malfunction; and
   a notification unit that notifies a user of the determined area to be captured.
2. The failure diagnosis system according to 1, further including:
   an image acquisition unit that acquires an image in which the area to be captured in the target vehicle is captured from an external apparatus after the notification; and
   a failure diagnosis unit that analyzes the image and performs failure diagnosis of the target vehicle.
3. The failure diagnosis system according to 1 or 2, wherein
   the malfunction determination unit
      detects a data abnormality indicating a behavior different from that under normal operation, based on the vehicle-related data and
      determines the malfunction, based on content of the detected data abnormality.
4. The failure diagnosis system according to 3, further including
a symptom information acquisition unit that acquires symptom information indicating a symptom occurring in the target vehicle, wherein
the malfunction determination unit determines the vehicle-related data being a target of detection of the data abnormality from a plurality of types of the vehicle-related data acquired by the vehicle-related data acquisition unit, based on the symptom information.
5. The failure diagnosis system according to 3 or 4, wherein
   the malfunction determination unit
      excludes, when a plurality of types of the data abnormalities are detected, the data abnormality occurring due to occurrence of the another data abnormality from the detected data abnormalities and
      determines the malfunction, based on content of the unexcluded data abnormality in the detected data abnormalities.
6. The failure diagnosis system according to any one of 1 to 5, further including
   a guidance information generation unit that generates guidance information providing guidance on at least one of an image capture angle and a distance to a subject when an image of the area to be captured is captured, wherein
   the notification unit notifies the user of the guidance information.
7. The failure diagnosis system according to 6, wherein
   the guidance information generation unit generates the guidance information varied for the each area to be captured.
8. The failure diagnosis system according to 6 or 7, wherein
   the guidance information generation unit generates the guidance information including a sample image.
9. A failure diagnosis method including, by a computer:
   acquiring vehicle-related data related to a target vehicle;
   determining a malfunction that may be occurring in the target vehicle, based on the vehicle-related data;
   determining an area to be captured for failure diagnosis, based on the determined malfunction; and
   notifying a user of the determined area to be captured.
10. A program causing a computer to function as:
   a vehicle-related data acquisition unit that acquires vehicle-related data related to a target vehicle;
   a malfunction determination unit that determines a malfunction that may be occurring in the target vehicle, based on the vehicle-related data;
   an image capture location determination unit that determines an area to be captured for failure diagnosis, based on the determined malfunction; and
   a notification unit that notifies a user of the determined area to be captured.

### REFERENCE SIGNS LIST

10 Failure diagnosis system
11 Vehicle-related data acquisition unit
12 Malfunction determination unit
13 Image capture location determination unit
14 Notification unit
15 Image acquisition unit
16 Failure diagnosis unit
17 Symptom information acquisition unit
18 Guidance information generation unit
20 On-vehicle apparatus
30 User terminal
40 Communication network
1A Processor
2A Memory
3A Input-output I/F
4A Peripheral circuit
5A Bus

What is claimed is:

1. A failure diagnosis system comprising:
at least one memory configured to store one or more instructions; and
at least one processor configured to execute the one or more instructions to:
acquire vehicle-related data related to a target vehicle;
determine a malfunction that may be occurring in the target vehicle, based on the vehicle-related data;
determine an area to be captured in the target vehicle for failure diagnosis, based on the determined malfunction; and
notify a user of the determined area to be captured.

2. The failure diagnosis system according to claim 1, wherein the processor is further configured to execute the one or more instructions to:
acquire, after the notification, an image of the area to be captured in the target vehicle, the image being captured from an external apparatus; and
perform failure diagnosis of the target vehicle based on analyzing the image.

3. The failure diagnosis system according to claim 1, wherein
the processor is further configured to execute the one or more instructions to:
detect a data abnormality indicating a behavior different from a behavior under normal operation, based on the vehicle-related data and
determine the malfunction, based on content of the detected data abnormality.

4. The failure diagnosis system according to claim 3, wherein the processor is further configured to execute the one or more instructions to:
acquire symptom information indicating a symptom occurring in the target vehicle, and
determine, based on the symptom information, the vehicle-related data used for detection of the data abnormality from a plurality of types of the vehicle-related data.

5. The failure diagnosis system according to claim 3, wherein the processor is further configured to execute the one or more instructions to:
in a case that a plurality of types of the data abnormalities are detected, exclude the data abnormality occurring due to occurrence of the another data abnormality from the detected data abnormalities and
determine the malfunction, based on content of the unexcluded data abnormality in the detected data abnormalities.

6. The failure diagnosis system according to claim 1, wherein the processor is further configured to execute the one or more instructions to:
generate guidance information providing guidance on at least one of an image capture angle and a distance to a subject for capturing the area to be captured, and
notify the user of the guidance information.

7. The failure diagnosis system according to claim 6, wherein
the processor is further configured to execute the one or more instructions to generate the guidance information varied for the each area to be captured.

8. The failure diagnosis system according to claim 6, wherein
the processor is further configured to execute the one or more instructions to generate the guidance information including a sample image.

9. A failure diagnosis method comprising, by a computer:
acquiring vehicle-related data related to a target vehicle;
determining a malfunction that may be occurring in the target vehicle, based on the vehicle-related data;
determining an area to be captured in the target vehicle for failure diagnosis, based on the determined malfunction; and
notifying a user of the determined area to be captured.

10. A non-transitory storage medium storing a program causing a computer to:
acquire vehicle-related data related to a target vehicle;
determine a malfunction that may be occurring in the target vehicle, based on the vehicle-related data;
determine an area to be captured in the target vehicle for failure diagnosis, based on the determined malfunction; and
notify a user of the determined area to be captured.
